(19) United States
(12) Patent Application Publication
(10) Pub. No.: US 2014/0352878 A1
(43) Pub. Date: Dec. 4, 2014

(54) APPARATUS AND METHOD FOR CONTINUOUS COATING OF SOLID DOSAGE FORMS AND SOLID OBJECTS

(71) Applicants: Newman Aguas Navarro, Barranquilla (CO); Carlos Salazar Altamar, Barranquilla (CO)

(72) Inventors: Daniel Contreras Julio, Barranquilla (CO); Newman Aguas Navarro, Barranquilla (CO); Carlos Salazar Altamar, Barranquilla (CO)

(21) Appl. No.: 13/903,965

(22) Filed: May 28, 2013

(51) Int. Cl. A61J 3/00

(52) U.S. Cl. CPC A61J 3/005
USPC 156/213; 156/383

(57) ABSTRACT

The invention provides a new method and apparatus for continuously coating solid dosage forms such as caplets by aligning and dispensing multiple solid dosage forms between two sheets of coating material as they enter cavities of a mold. The coating sheets must be flexible and ductile to practice the invention and must adhere to each other and to the solid dosage form, either because of their self-adhering nature or because of an additional adhering agent present in or on the coating sheet. The present invention also relates to a method and apparatus for orienting and molding an array of small solid products between two sheets, for example, in packaging. The present invention also related to a method for using material fabricated into a flexible, ductile sheet to coat solid objects in a mold. The apparatus of this invention can be linked to an overall system for continuously making coated solid dosage forms or other coated or packaged items.

This application claims the priority benefit under 35 U.S.C. section 119 of U.S. Provisional Patent Application No. 61/651,572 entitled “Apparatus And Method For Continuous Coating Of Solid Dosage Forms And Solid Objects” filed on May 25, 2012; which is in its entirety herein incorporated by reference.

### FIELD OF THE INVENTION

The present invention generally relates to continuous coating of solid dosage forms and to the method and apparatus for manufacturing the same. The instant invention further relates to packaging solid objects and to coating solid materials between two sheets of coating a mold.

This invention also relates to film-coated unitary-dosage forms such as medicine tablets, or caplets, and to methods and equipment for manufacturing such products. More particularly, the invention pertains to medicines and the like comprising tablets or caplets of one-piece tablet or caplet of certain geometrical forms which are coated in preferably digestible or erodable films applied to the tablets or caplets separately from formation of the tablets or caplets. The invention also features gelatin-based and other films for coating such tablets or caplets, to methods for coating such tablets or caplets with such films, and to equipment for performing such methods to produce such products.

More specifically, the present invention also provides a method and apparatus for coating caplets with a layer of gelatin or other gel-like substances.

The invention also provides a method for producing an array of oriented objects held in a sheet of coating material or packaging.

Additionally, the invention relates to processes for making coated dosage forms, such as medicaments, but can also be food or decorative items. Additionally, the invention relates to packaging of objects between two sheets. The sheets must be ductile and flexible at the time of coating or packaging, but need not be ductile or flexible once coating or packaging is complete.

### BACKGROUND OF THE INVENTION AND DESCRIPTION OF THE PRIOR ART

Over the years, various oral dosage forms have been developed pharmaceuticals and dietary supplements. Among the more popular oral dosage forms are capsules, tablets, softgel capsules, and more recently, gelcaps. Tablets are compressed or molded solid dosage forms of any size or shape. Solid, generally oblong-shaped tablets may sometimes be referred to as caplets. Tablets are very popular with consumers, however uncoated tablets suffer from drawbacks such as medicinal taste, a tendency to powder or flake (i.e., physical disintegration) when packaged in bottles, and/or the perception by consumers that they are not easy to swallow. These limitations are eliminated by coating the tablets with a polymeric coating.

During most of the last century, hard gelatin capsules were the dosage form of choice for prescription and over-the-counter drugs. Capsules are hard shell compartments made of two halves, including a body and a cap, wherein the cap partially and snugly overlaps with the body to enclose a dosable drug ingredient therein. The enclosed dosable ingredient is most often a powder, liquid, paste or similar nonsolid form.

Empty hard shell capsules are produced by a conventional dip-molding process and consumers have found that such capsules are aesthetically pleasing, easy to swallow and mask the medicine taste of the drug contained therein. In addition, the bodies and caps of such capsules are often produced in different colors, resulting in a bi-colored capsule product having enhanced aesthetic appeal, as well as improved product identification and brand recognition by consumers. Many patients preferred capsules over coated or uncoated tablets, prompting pharmaceutical manufacturers to market certain products in capsule form even when they were also available in tablet form. However, due to potential tampering concerns, capsules are no longer a preferred delivery choice for consumer (i.e., over-the-counter) pharmaceuticals.

An additional alternative to capsule products are caplets, which are solid, oblong tablets that are often coated with various polymers such as cellulose ethers to improve their aesthetics, stability, and swallowability. Typically, such polymers are applied to the tablets either from solution in organic solvents, or from aqueous dispersion via spraying. Still other methods involve spray coating tablets with a gelatin coating solution.

A further alternative to capsule products are gelcaps, which are, consumer-preferred dosage forms comprising solid tablets covered with a glossy gelatinous coating. In the present marketplace, gelcaps are among the most popular oral dosage forms. Several methods of producing gelcaps have been developed in an effort to provide tamper-proof capsule-like products. One category of such methods involve dipping tablets, one half at a time, into gelatin coating solutions, which can be of two different colors. Another category of such methods involves shrink-fitting the capsule halves onto a tablet form. An additional method involves sealing the body and cap of the capsule at the overlapping seam therebetween. Another method of producing gelcaps is via an coating process wherein two separate films made of gelatinous material are applied to opposite sides of a tablet by a pair of rotary dies.

There are various advantages that a coating gives to solid dosage forms. It tends to facilitate swallowing, particularly where the solid dosage form has an objectionable flavor or texture. It allows for color coding, for protection of the solid dosage form from crumbling or chemical degradation, for the possibility of supplemental ingredients, and so forth. These advantages of coating are well known in the art.

The methods and apparatuses for coating, though useful, have the disadvantages of being complex in their handling of solid dosage forms. For example, there may be multiple stages of dipping, orienting, drying, heating, and cooling. In the case of batch processes, there is also a need for cleaning between batches, as well as other disadvantages of batch systems, such as the need for more apparatus and space, more sampling for quality control, and greater variability in finished products. Where the coating apparatus or method is continuous, it is nonetheless may be difficult for the apparatus to handle imperfections in the feeding of items to be coated. For example, there may be voids in the feed line or products may become detached from the manipulation system, thereby causing coating to be deposited in a place other than that intended.

Apparatuses, systems, and methods for manufacturing coated dosage forms that also use a mold are disclosed in U.S. Pat. Nos. 6,837,696 and 6,767,200. The apparatus for coating the dosage forms requires pressure and vacuum, as well as heat, and applies the coating in two stages and requires a flowable coating formulation.

Apparatuses, systems, and methods for manufacturing coated dosage forms that use a rotary mold in which the cavities have a circular path are described in U. S. Pat. Applications 20030086973 and 20030124183. These inventions involve the injection of flowable coating, and require both heat and cooling and are generally more complicated than the present invention.

The present invention, although reliant on careful control of the properties of the coating sheets, has the advantages of simplicity in the design of the coating apparatus and fewer problems associated with the feeding of solid dosage forms to the coating apparatus. In other words, a breakdown in the feeding of product results only in the waste of coating material, and does not foul or otherwise interfere with the continued operation of the coating apparatus.

The use of gelatin ribbon, similar in processing properties to gelatin sheets, is described in U.S. Pat. No. 6,797,201. The formulation of gelatin coatings to form a ribbon or sheet of uniform thickness is described in U.S. Pat. No. 5,246,635. Other patents that take advantage of gelatin's ductility include U.S. Pat. Nos. 5,672,300 and 6,022,499.

### BRIEF DESCRIPTION OF THE DRAWINGS

FIG. 1 is a three dimensional top view of an embodiment of an assembled coating apparatus with a product aligning and feeding system.

FIG. 2 is a three dimensional view of an embodiment of a feeding means and an orienting means containing caplets.

FIGS. 3, 3a, 3b and 3c are a partially schematic cross-sectional view of an embodiment of the holding and dispensing means containing caplets.

FIG. 4 is a three dimensional view of an embodiment of the holding and dispensing means containing caplets.

FIG. 5 is a side view of the bottom part of an embodiment showing the solid dosage forms as they leave the molding means.

### OBJECTS OF THE INVENTION

It is an object of the present invention to provide a simple method and apparatus for continuously coating solid dosage forms and that tolerates small disruptions in the continuous feeding of uncoated solid dosage forms to the coating process.

It is another object of the present invention to provide a simple method of encasing oriented objects in a single sheet of coating or packaging material.

It is another object of the invention to make better use of gelatin's properties when used as a coating material.

It is a further object of the invention to provide improved film compositions for use in coating tablets and caplets and other solid forms for various purposes. The compositions include a soft elastic gelatin film which provides a securely bonded coating around a solid tablet, thereby providing a tablet or caplet having enhanced tamper-evident properties.

Other objects and embodiments of the present invention will be discussed below. However, it is important to note that many additional embodiments of the present invention not described in this specification may nevertheless fall within the spirit and scope of the present invention and/or the claims.

### SUMMARY OF THE INVENTION

The present invention relates to an apparatus providing a simple means for coating solid dosage forms, such as caplets, thereby avoiding batch processes and complex product manipulation. In one embodiment, caplets are placed in the hopper of a vibratory conveyor, an embodiment of the feeding means. Caplets with bilateral symmetry move toward a plurality of channels, passing under a plate that only allows caplets with the smallest vertical dimension through. The vertically oriented caplets pass through channels which gradually narrow, thereby providing longitudinal orientation as well. These two stages are an embodiment of the orienting means. The caplets can also be fed to the coating apparatus from a production line that provides the needed vertical and longitudinal orientation.

The caplets pass into flexible channels which are connected to a vibratory conveyor, either through their connection with a hopper or with another section within the feeding means. As the caplets approach the molding means, they pass into a holding and dispensing means. The holding means maintains their vertical and longitudinal relationships. In one embodiment, the vertical orientation gradually changes approximately 90 degrees to allow gravity to augment vibration as the feeding means. This holding means can have an upper movable section for holding caplets and a lower dispensing wedge for releasing caplets. In one embodiment, the holding and dispensing means are within one unit. As the upper section (holding means) moves back and forth, the timing and placement of the release of caplets to the lower section (or dispensing means) can be precisely controlled. In one embodiment, the holding means is moved by a pneumatic system connected to a movable rod that moves in conjunction with the holding means. The timing of release of the caplets is easily controlled by computer means and is coordinated with the die roll pockets.

If the molding means is a pair of rotating cylindrical molds with cavities, caplets can be released from the dispensing wedge into the cavities. The coating material is provided as flexible, ductile sheets that are fed on the anterior and posterior sides of the dispensing means. Thus, through placement and timing of the release, caplets enter the cavities between sheets of flexible, ductile material. In various embodiments, these sheets can have multiple layers that accomplish various coating functions, such as providing texture, flavor, color, medicants, mechanical properties, adhesiveness, and other desired features.

Among coating media, a useful ingredient for many embodiments is gelatin, which provides the well-known advantages of flexibility and ductility at low cost. Gelatin can easily be formulated into sheets that can be continuously fed to a mold. Other film formers such as natural or synthetic films can be used in the practice of the invention.

The invention also provides an apparatus for coating solid dosage forms comprising: a plurality of channels containing solid dosage forms aligned vertically and longitudinally; two flexible, ductile continuous coating sheets fed on opposite sides of said solid dosage forms, proximal to the joining of said plurality of channels to a holding and dispensing means; a holding and dispensing means that places multiple solid dosage forms between said two flexible, ductile sheets of coating material with precise timing and placement; a molding means that accepts said solid dosage forms and said coating sheets and provides coated solid dosage forms that forms a single molded coating sheet holding coated solid dosage forms.

The invention is also directed to an apparatus for coating solid dosage forms comprising: a feeding means for conveying multiple solid dosage forms along a plurality of channels with an entrance and an exit; an orienting means for placing said solid dosage forms in the necessary longitudinal and axial orientation proximal to the entrance of said plurality of channels, two flexible, ductile continuous coating sheets positioned on opposite sides of said solid dosage forms proximal to the exit of said plurality of channels; a holding and dispensing means that places multiple solid dosage forms said between said two flexible, ductile sheets of coating material; a molding means that accepts said solid dosage forms and said coating sheets and provides coated solid dosage forms that forms a single molded coating sheet that holds coated solid dosage forms.

The instant invention further provides a method of continuously coating a plurality of solid dosage forms by providing feeding of said solid dosage forms; orienting of solid dosage forms; holding and dispensing, with precise timing and in between two continuous sheets of coating material, said solid dosage forms into opposing cavities of rotary molds, and releasing coated solid dosage forms surrounded by a single sheet of coating material.

In another aspect of the invention, this invention provides an improved soft elastic gelatin composition useful to form the coating film for the tablets and caplets of the invention. The composition typically comprises 45% by weight gelatin, 9% by weight glycerol as a plasticizer, and the balance consisting essentially of water and such colorants as may be useful. The gelatin has a bloom value in the range of from 150 to 180.

Yet in still another aspect of the invention, this invention describes a process for film coating of unitary dosage forms such as medicinal tablets and caplets of desired composition, shape and size. The method includes the steps of providing a pair of films, moving the films, heating the films, dispensing tablets or caplets to the films, contacting the films peripherally around the tablets or caplets from opposite sides of the tablets or caplets, sealing the contacted films to each other around the tablets or caplets, and separating the tablets or caplets as so coated by the films from the films. The films are provided to have selected thickness and composition. When heated to a predetermined temperature within a selected range of temperatures, the films are elastic, plastic and self-adhering to each other. The films come together during performance of the contacting step. The films are moved at essentially equal velocities along selected paths which pass through a place of coaction of a pair of coacting dies where the surfaces of the films are brought into contact with each other. The dies have cooperating working surfaces which are configured to form between them, on coaction of the dies, at least one cavity which is sized and shaped for loosely receiving therein a single article tablet or caplet. Heating of the films is performed on the surface of at least one of the films, which surface is heated to the predetermined temperature. Heating is performed at a location along the paths proximate to the place of die coaction. In tablet or caplet dispensing, one tablet or caplet for each cavity formed between the coacting dies is dispensed individually into contact with the surface of at least one of the films at a location which corresponds to the location of a cavity. The dispensed tablet or caplet moves with the film to the place of die coaction. Contacting of the films is performed at the place of die coaction. The films are contacted with each other around the tablets or caplets to cause each tablet or caplet to be coated between the films and by the films. As separated from the films after the sealing step is performed, each single tablet or caplet as sealed between layers of the film material comprises an article of manufacture produced by the method.

In another aspect of the invention, the invention provides apparatus for film coating a series of essentially identical separate article tablets or caplets of selected size and shape. The apparatus comprises a pair of matching dies which have coacting working surfaces which are configured for defining between the dies, upon movement of the working surfaces into coacting relation at a selected place, at least one cavity of sufficient size and shape to receive loosely therein a single one of the article tablets or caplets. Film moving means are provided and are operable for moving two elastic and cosealable films of selected thickness and composition along respective paths which converge at the place of coaction between the die working surfaces with the films disposed in overlying relation to the respective cavity defining features of the die surfaces. Means cooperate with the film paths for creating in the films moving therealong to the place of die coaction predetermined conditions of plasticity and axial tension in the films as disposed in overlying relation to the die working surfaces. Tablet or caplet dispensing means are located proximate the place of die coaction and are operable for dispensing tablets or caplets individually to at least one of the films in a selected orientation of the dispensed tablets or caplets relative to the dies at respective film locations which correspond to the die cavities. The dispensed tablets or caplets move with the at least one film to the place of die coaction for coating engagement at that place between the films within the die cavities. Drive means move the dies into and out of coacting relation at the desired place along the file paths. The dies are formed to cause them, when moving into the coacting relation, to apply the films to the tablets or caplets from opposite sides of the tablets or caplets, to cut the film layers applied to the tablets or caplets from the remainder of the films, and to seal the applied film layers to each other in essentially edge-to-edge relation about the tablets or caplets. The apparatus also includes means for separating the converged films from film coated tablets or caplets.

### DETAILED DESCRIPTION OF THE INVENTION

The present invention provides methods and apparatuses to coat a variety of solid dosage forms i.e., caplets or other solid objects. The invention can be used with a wide variety of shapes and sizes and can be linked to the manufacturing of solid dosage forms or used independently. The coating can have a variety of ingredients, so long as they can be formulated into sheets that are sufficiently flexible and ductile that they can be accepted by the solid dosage forms as they enter the cavities of a mold.

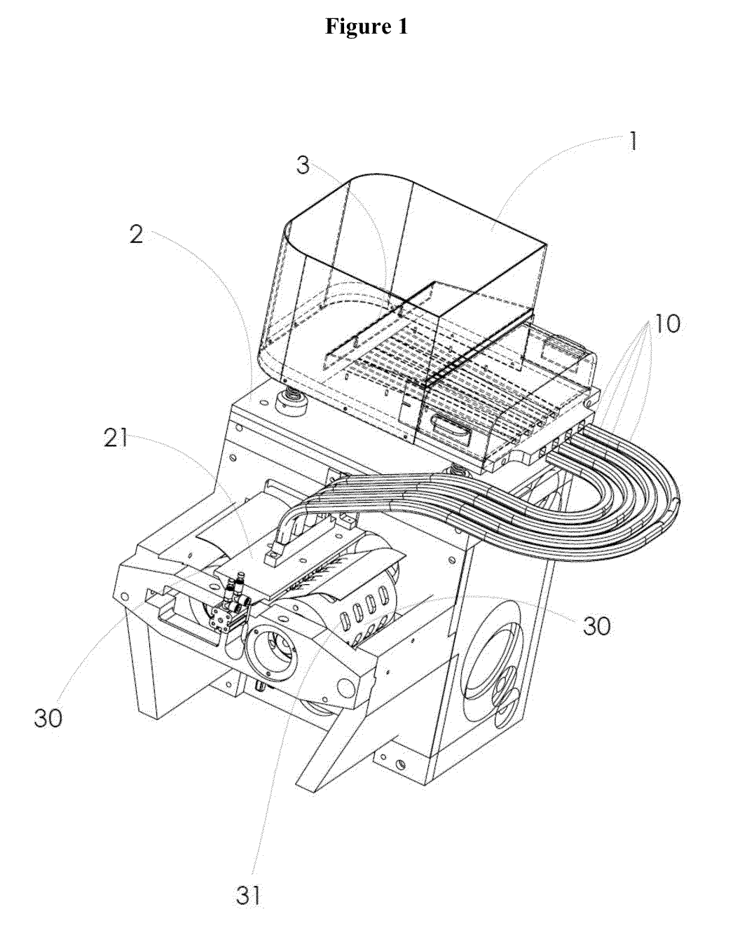

FIG. 1 is a three dimensional top view of a preferred embodiment of the assembled coating apparatus. It shows a hopper 1 in which solid dosage forms such as caplets are placed, a vibrator 2 that provides vibratory conveying, and a vertical spacer 3 that prevents solid dosage forms that are not laying with their smallest dimension in the vertical plane from entering the plurality of flexible channels 10 that also vibrate. The hopper may be clear to facilitate monitoring or it may be of stainless steel or other inert material. If the solid dosage forms have axial symmetry, it is not necessary to have vertical spacer 3.

The flexible channels provide solid dosage forms to a holding and dispensing means 21. The orientation of the channels gradually changes between the hopper 1 and the holding and dispensing means 21. Solid dosage forms with bilateral symmetry most easily retain their orientation if the channels have a flattened bottom. The flexible or rigid channels may be of polypropylene or another polymer suited to a pharmaceutical application. Solid dosage forms, along with coating sheets, are fed to molds 30 containing opposing cavities 31 in which solid dosage forms are to be coated, for example, by heating the molds 30 or providing pressure in the molding cavities. Modest pressures can easily be generated with the coming together of the cavities if the volume of solid dosage forms and coating sheets slightly exceeds the combined volume of the opposing mold cavities. The coating material outside the cavities can serve to temporarily seal the mold cavities. Depending on the composition of the coating sheets, it may also be desirable to heat the molds or to use an adhesive layer on the facing sides of the coating sheets 20.

The thickness of the sheets or films 20 is a factor, among others, which affects the resiliency of the gelatin films during the caplet coating process. The stretchability of the film over a caplet is also affected by the film thickness. The minimum film thickness which can be used for successful coating of caplets is in turn affected by the type of gelatin used to create films 20 and by the gelatin-liquid formulation. In a rotary die caplet coating apparatus of the kind described above, it has been found that films having a thickness of from 0.02 to 0.05 inches thick worked well, although films having a thickness of 0.01 inch also were handled successfully. As noted above, if equipment of definition different from that described above is used, films of lesser or substantially greater thickness can be handled.

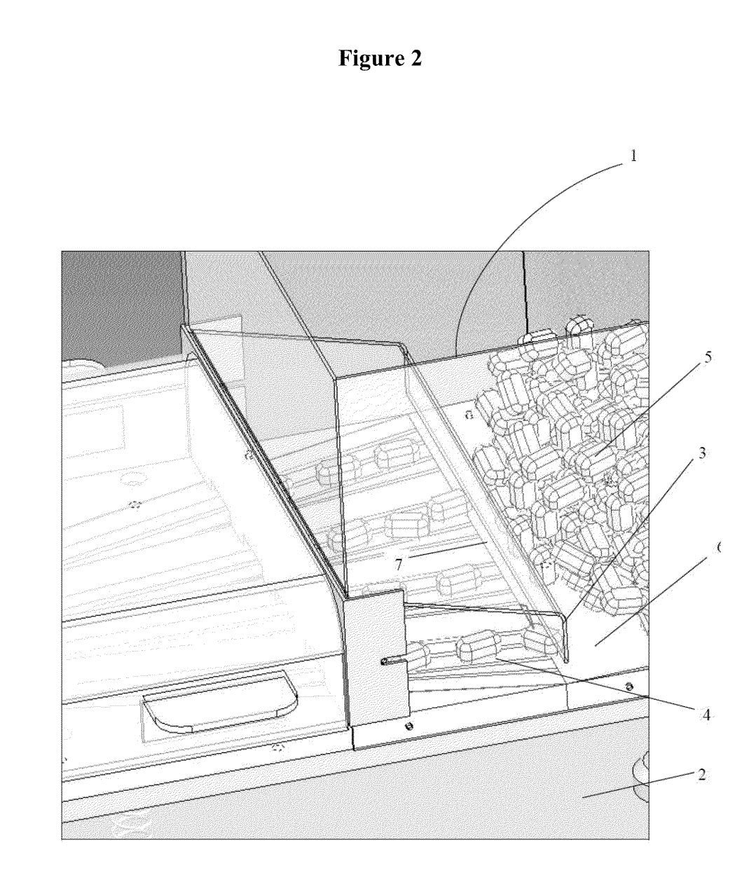

FIG. 2 is an enlarged view of the feeding means containing the solid dosage form caplets 5. The caplets are placed in a hopper 1 and are fed by means of vibratory conveying caused by a vibrator 2 under the hopper. Feeding is facilitated if the path of the conveyor 6 has a slightly downward pitch. After passing under a barrier 3 that provides a spacing 7 that permits only caplets with proper vertical orientation to pass, the caplets are shown entering a path 4 that narrows and provides further orienting. The hopper 1 and the vertical spacer 3 and narrowing path 4 are not necessary if the coating apparatus is linked to a solid dosage manufacturing process in which the product orientation has been maintained. In such a linked embodiment, solid dosage forms can be fed directly to the flexible channels 10.

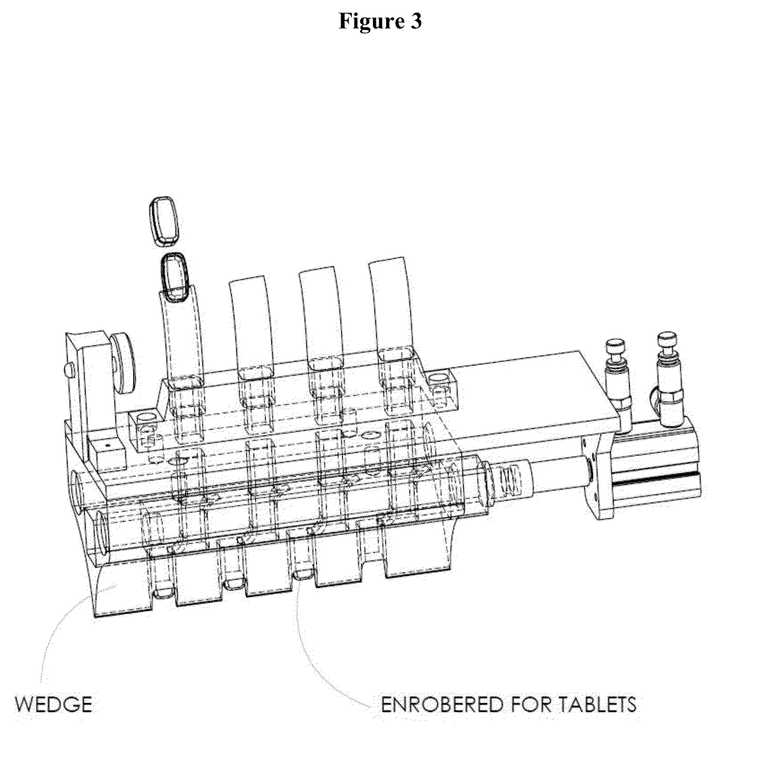

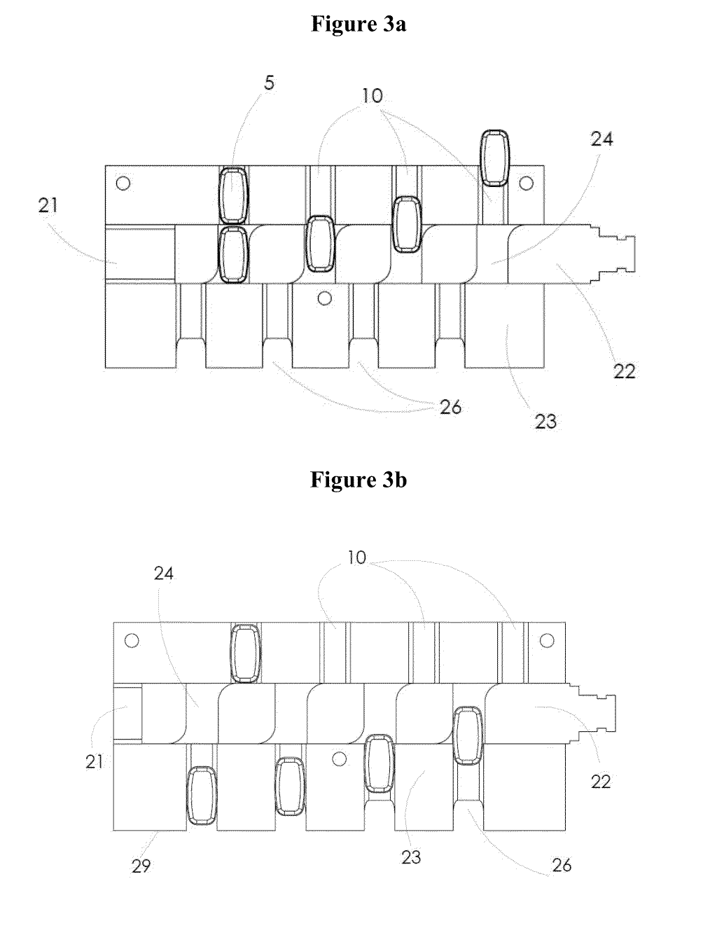

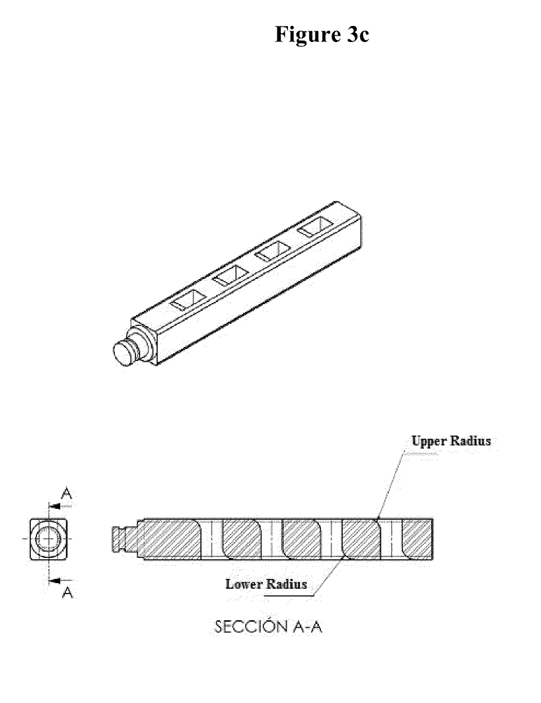

FIG. 3 is a schematic view of the holding and dispensing means 21 connected to a plurality of rigid or flexible channels 10. FIG. 3a shows caplets 5 entering from channels 10 into short channels 24 and being held in a holding means 22 having a radius of curvature. In one embodiment, a pneumatic device 27 causes a rod 28 to move the holding means 22 back and forth. After the movement of the pneumatic device, the solid dosage form then move into channels 24 in the dispensing wedge 23. FIG. 3b shows caplets being dropped from the dispensing wedge 23 while being cut off from receiving additional product from flexible channels 10.

In the present invention, the solid dosage form is aligned directly in the rigid feeding channels, while in the prior art the alignment is done right at the wedge. The present apparatus does not need a motorized wedge to effect the instant process.

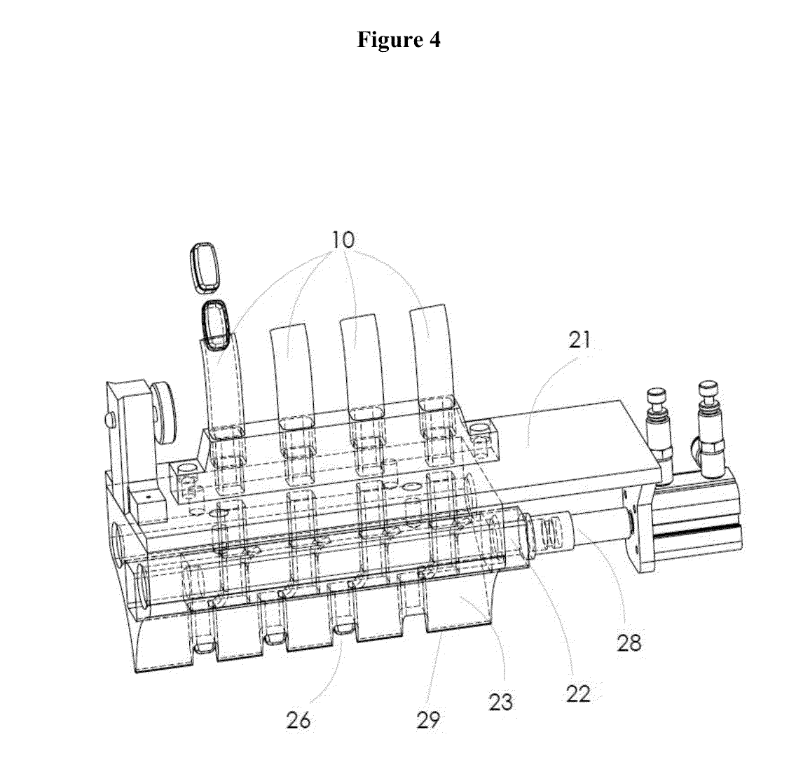

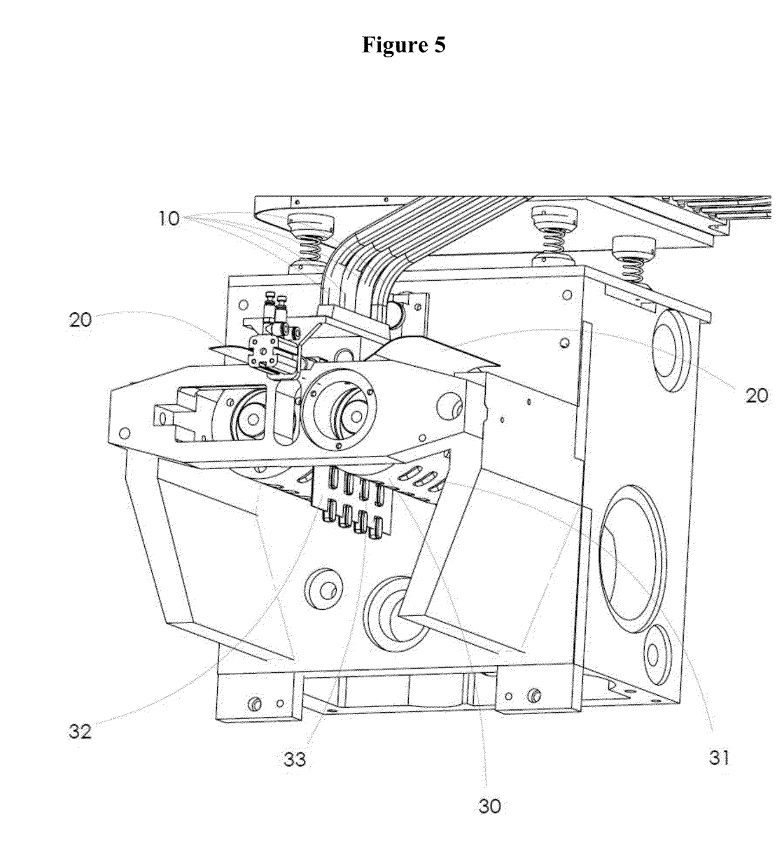

FIG. 4 is a three dimensional view of the holding and dispensing means. Because of the tapered edge, the dispensing wedge 29 allows the holding and dispensing means to be in close proximity to the molds, solid dosage forms are unable to move downward until they are aligned with opposing molding cavities 31 (as can be seen in FIGS. 1 and 5).

FIG. 5 is a side view of the bottom part of the coating apparatus. Coated solid dosage forms 33 are contained in a single molded sheet 32. These can then be separated by mechanical means, such as cutting. In the case of an embodiment in which an array of solid dosage forms or other objects are to be packaged or the finished product is to be dispensed within the single sheet, the cutting step is not needed.

The purpose of the above description is to illustrate some configurations and uses of the present invention, without implying any limitation. Although the present invention has been described with reference to specific details of certain embodiments thereof, it is not intended that such detail should be regarded as limitations upon the scope of the invention, except as and to the extent that they are included in the accompanying claims.

What is being claimed is:

1. An apparatus for coating solid dosage forms comprising:
a plurality of channels containing solid dosage forms aligned vertically and longitudinally;
two flexible, ductile continuous coating sheets fed on opposite sides of said solid dosage forms, proximal to the joining of said plurality of channels to a holding and dispensing means;
a holding and dispensing means that places multiple solid dosage forms between said two flexible, ductile sheets of coating material with precise timing and placement said holding and dispensing means having internal curvature;
a molding means that accepts said solid dosage forms and said coating sheets and provides coated solid dosage forms that forms a single molded coating sheet holding coated solid dosage forms.

2. The apparatus of claim 1 in which said coated solid dosage forms are separated from said single sheet by a mechanical means such as cutting.

3. The apparatus of claim 1 in which said solid dosage forms are tablets.

4. The apparatus of claim 1 in which said feeding means comprises a hopper with a vibratory conveyor in which said hopper is joined to said plurality of channels, said channels being flexible so that the vibratory conveyor with said hopper also provides vibratory conveying in the plurality of rigid channels and alignment of the solid dosage form.

5. The apparatus of claim 1 in which said orienting means comprises: a height restricting device such that only solid dosage forms with the smallest dimension in the vertical plane can pass under it, and a plurality of narrowing passages that provide longitudinal orientation of the solid dosage forms to said flexible channels.

6. The apparatus of claim 1 in which said molding means comprises 2 parallel, horizontal cylindrical molds with opposing cavities that align to receive and mold said flexible, ductile sheets and said solid dosage forms, also including a means for joining said flexible, ductile sheets to each other and to said solid dosage forms, including but not limited to pressure, heat, or a joining substance.

7. The apparatus of claim 1 in which said flexible, ductile sheets have a plurality of layers, and may include a layer for providing strength or adhesive properties to the flexible ductile sheet.

8. The apparatus of claim 1 in which said flexible, ductile sheets contain gelatin, cellulosic film formers or synthetic film formers.

9. The apparatus of claim 1 in which said holding and dispensing means includes: an upper movable part with multiple, parallel channels wherein each channel holds only one said solid dosage form; a lower, non-moveable wedge-like part which is placed below said upper movable part and in between said flexible, ductile sheets and proximal to said molding means, and which allows said solid dosage forms to enter said cavities of said molding means while between said flexible, ductile sheets; a means for moving said upper part into and out of alignment with said lower part, thereby allowing said solid dosage forms to be held or dispensed in coordination with the movement of said molding means.

10. The apparatus of claim 9 in which said holding and dispensing means has a substantially vertical orientation that permit the solid dosage forms to move by gravity into said cavities of said molding means.

11. An apparatus for coating solid dosage forms comprising:
a feeding means for conveying multiple solid dosage forms along a plurality of channels with an entrance and an exit;
an orienting means for placing said solid dosage forms in the necessary longitudinal and axial orientation proximal to the entrance of said plurality of channels, two flexible, ductile continuous coating sheets positioned on opposite sides of said solid dosage forms proximal to the exit of said plurality of channels;
a holding and dispensing means that places multiple solid dosage forms said between said two flexible, ductile sheets of coating material;
a molding means that accepts said solid dosage forms and said coating sheets and provides coated solid dosage forms that forms a single molded coating sheet that holds coated solid dosage forms.

12. The apparatus of claim 11 in which said coated solid dosage forms are separated from said single sheet by a mechanical means such as cutting.

13. The apparatus of claim 11 in which said solid dosage forms are tablets.

14. The apparatus of claim 11 in which said feeding means comprises a hopper with a vibratory conveyor in which said hopper is joined to said plurality of channels, said channels being flexible so that the vibratory conveyor with said hopper also provides vibratory conveying in the plurality of flexible channels.

15. The apparatus of claim 11 in which said orienting means comprises:
a height restricting device such that only solid dosage forms with the smallest dimension in the vertical plane can pass under it, and a plurality of narrowing passages that provide longitudinal orientation of the solid dosage forms to said flexible channels.

16. The apparatus of claim 11 in which said molding means comprises 2 parallel, horizontal cylindrical molds with opposing cavities that align to receive and mold said flexible, ductile sheets and said solid dosage forms, also including a means for joining said flexible, ductile sheets to each other and to said solid dosage forms, including but not limited to pressure, heat, or a joining substance.

17. The apparatus of claim 11 in which said flexible, ductile sheets have a plurality of layers, and may include a layer for providing strength or adhesive properties to the flexible ductile sheet.

18. The apparatus of claim 11 in which said flexible, ductile sheets contain gelatin.

19. The apparatus of claim 11 in which said holding and dispensing means includes: an upper movable part with multiple, parallel channels wherein each channel holds only one said solid dosage form; a lower, non-moveable wedge-like part which is placed below said upper movable part and in between said flexible, ductile sheets and proximal to said molding means, and which allows said solid dosage forms to enter said cavities of said molding means while between said flexible, ductile sheets; a means for moving said upper part into and out of alignment with said lower part, thereby allowing said solid dosage forms to be held or dispensed in coordination with the movement of said molding means.

20. The apparatus of claim 9 in which said holding and dispensing means has a substantially vertical orientation that permit the solid dosage forms to move by gravity into said cavities of said molding means.

21. A method of continuously coating a plurality of solid dosage forms by providing feeding of said solid dosage forms; orienting of solid dosage forms; holding and dispensing, with precise timing and in between two continuous sheets of coating material, said solid dosage forms into opposing cavities of rotary molds, and releasing coated solid dosage forms surrounded by a single sheet of coating material.
